(19) United States
(12) Patent Application Publication
(10) Pub. No.: US 2014/0254995 A1
(43) Pub. Date: Sep. 11, 2014

(54) CELL TOWER CABLE ASSEMBLY AND SYSTEM

(71) Applicants: Donald K. LARSON, (US); Richard L. SIMMONS, Saint Paul, MN (US); Robert M. ANDERTON, Saint Paul, MN (US); Curtis L. SHOEMAKER, Saint Paul, MN (US); Stephen C. KING, Saint Paul, MN (US); 3M INNOVATIVE PROPERTIES COMPANY, ST. Paul, MN (US)

(72) Inventors: Curtis L. Shoemaker, Round Rock, TX (US); Robert M. Anderton, Cedar Park, TX (US); Richard L. Simmons, Leander, TX (US); Stephen C. King, Lakeway, TX (US); Donald K. Larson, Cedar Park, TX (US)

(73) Assignee: 3M Innovative Properties Company, St. Paul, MN (US)

(21) Appl. No.: 14/233,277

(22) PCT Filed: Sep. 21, 2012
(86) PCT No.: PCT/US12/56498

§ 371 Date: Jan. 16, 2014

Related U.S. Application Data
(60) Provisional application No. 61/540,203, filed on Sep. 28, 2011.

(51) Int. Cl. G02B 6/44

(52) U.S. Cl. CPC G02B 6/4495; G02B 6/4429
USPC 385/101; 385/106

(57) ABSTRACT

A cable assembly for cell tower communications comprises a plurality of optical fiber cable units disposed within a unitary cable assembly jacket that surrounds the optical fiber cable units. The cable assembly jacket has a plurality of indentations disposed between adjacent optical fiber cable units that allow an installer to furcate the cable assembly into smaller cable groupings at a convenient cell tower location.

The present invention relates to a cable assembly and system for routing optical fibers directly from a cell tower base to remote radio units (RRUs) located at each antenna location.

### BACKGROUND

The continuing expansion of wireless communication and its accompanying wireless technology will require many more “cell sites” than currently deployed. This expansion has been estimated from a doubling to a ten-fold increase in the current number of cell sites, particularly in the deployment of 4G/LTE. This dramatic increase in the number of cell sites is due, in large part, to the high bandwidth demand for wireless applications and the bandwidth to the cell site must be shared to the available UE (user equipment) within range of the site.

Better wireless communication coverage is needed in order to get the bandwidth to the increasing number of customers that demand it. Thus, new deployments of traditional, large “macro” cell sites, which typically include large cell towers, are continuing. With that increased cell tower deployment, there is a need for additional accessories and components used to distribute cables and wiring on the cell towers.

### SUMMARY

According to a first aspect of the present invention, a cable assembly for cell tower communications comprises a plurality of optical fiber cable units disposed within a unitary cable assembly jacket that surrounds the optical fiber cable units, the cable assembly jacket having a plurality of indentations disposed between adjacent optical fiber cable units that allow an installer to furcate the cable assembly into smaller cable groupings at a convenient cell tower location.

In one aspect, each optical fiber cable unit includes duplex fibers. In another aspect, each fiber cable unit includes strength members. In another aspect, each optical fiber cable unit is configured as an FRP cable.

In another aspect, the cable assembly jacket is formed from a UV stabilized polyethylene material.

In another aspect, the cable assembly comprises at least six optical fiber cable units. In another aspect, the cable assembly comprises at least eight optical fiber cable units.

According to another aspect of the present invention, a cell tower cabling system comprises a cable assembly having a plurality of optical fiber cable units disposed within a unitary cable assembly jacket that surrounds the optical fiber cable units, the cable assembly jacket having a plurality of indentations disposed between adjacent optical fiber cable units, each optical fiber cable unit configured to carry a communications signal to or from a cell tower base station. The cell tower cabling system also comprises a furcation location near the cell tower antennas, wherein the cable assembly is furcated into multiple subassemblies of cable units that are routed to remote radio units disposed near the antenna locations.

In another aspect, the cell tower cabling system further comprises a plurality of cell tower cable guides disposed on a cell tower frame to position the cable assembly as it routed up the cell tower.

In another aspect, each subassembly includes two sets of duplex fibers. In a further aspect, each subassembly can be further divided to send and receive units located at a respective remote radio unit, wherein each cable unit includes an active fiber and a spare fiber.

The above summary of the present invention is not intended to describe each illustrated embodiment or every implementation of the present invention. The figures and the detailed description that follows more particularly exemplify these embodiments.

### BRIEF DESCRIPTION OF THE DRAWINGS

The present invention will be further described with reference to the accompanying drawings, wherein:

FIG. 1A is a front view of an exemplary cable assembly according to an aspect of the invention.

FIG. 1B is a front view of an individual cable unit.

FIG. 2 is a schematic representation of a conventional cell tower.

FIG. 3 is a schematic representation of a cable assembly system for a cell tower according to another aspect of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the scope of the invention as defined by the appended claims.

### DETAILED DESCRIPTION

In the following Detailed Description, reference is made to the accompanying drawings, which form a part hereof, and in which is shown by way of illustration specific embodiments in which the invention may be practiced. In this regard, directional terminology, such as “top,” “bottom,” “front,” “back,” “leading,” “forward,” “trailing,” etc., is used with reference to the orientation of the Figure(s) being described. Because components of embodiments of the present invention can be positioned in a number of different orientations, the directional terminology is used for purposes of illustration and is in no way limiting. It is to be understood that other embodiments may be utilized and structural or logical changes may be made without departing from the scope of the present invention. The following detailed description, therefore, is not to be taken in a limiting sense, and the scope of the present invention is defined by the appended claims.

Evolving requirements for increased data capability to support “smartphones” are driving the implementation of distributed radio systems with power amplifiers and radios mounted on the tower. In one aspect of the present invention, a rugged optical fiber cable assembly having multiple optical fibers capable of carrying digital communication protocols in a single cable assembly is provided for harsh cell tower environments. This structure removes the need to route individual fibers from the tower base unit to a sealed junction box, where the optical fibers would be terminated into a patch panel or the like. Instead, with the tower cable of the present invention, optical fibers can be routed directly from the tower base to remote radio units (RRUs) located at each antenna location. In addition, the tower cable can be furcated in a straightforward manner at the top of the cell tower. As such, more RF connections from the remote radio unit (RRU) to the antenna can be provided. This architecture can enable advanced antennas such as Multiple In Multiple Out (MIMO) antennas to be utilized to gain the requisite signal-to-noise ratio required to support very high bandwidth LTE/4G mobile services.

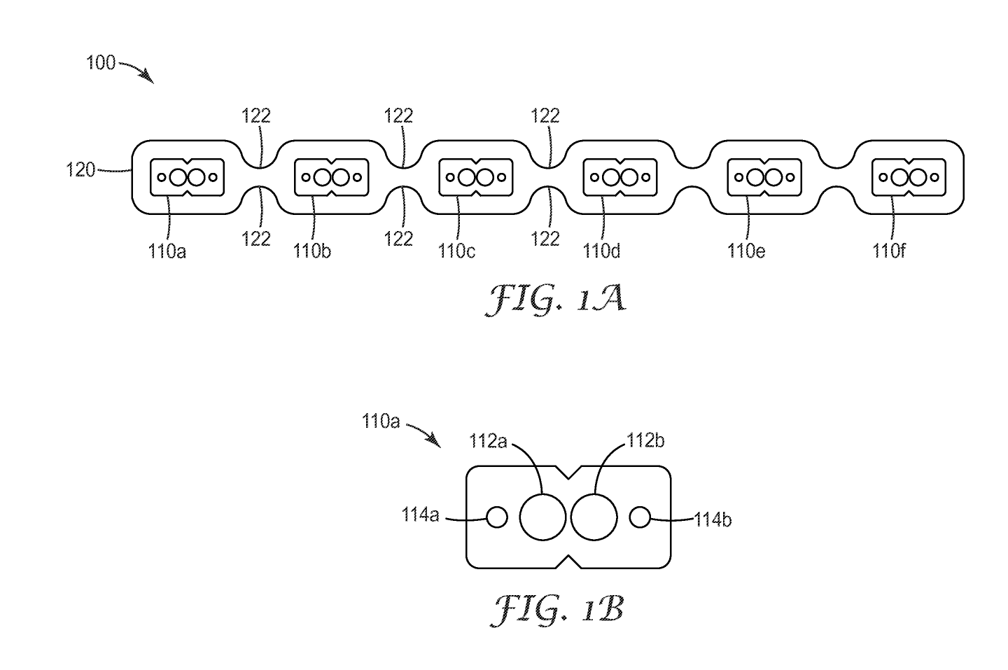

FIG. 1A shows a front view of a rugged optical fiber cable assembly 100 for use in cell tower installations according to an exemplary aspect of the invention. Cable assembly 100 includes multiple individual cable units 110a-110f formed as a single assembly within a jacket 120. In this exemplary aspect, six individual cable units are coupled into the assembly via jacket 120 in a side-by-side manner. In alternative aspects, a greater number (such as eight), or a fewer number (such as four) individual cable units can be coupled into the assembly via jacket 120, depending on the cell tower antenna configuration and signal provider requirements.

The cable assembly jacket 120 is configured to cover each individual cable unit 110, providing a unitary construction. In addition, the cable assembly jacket 120 includes a plurality of indentations 122 that allow the installer to furcate the cable assembly into smaller cable groupings at a convenient cell tower location (e.g., near the antennas).

In one aspect, the cable assembly jacket 120 is formed from a polymer material, such as polyethylene. In another aspect, the cable assembly jacket 120 is formed from a UV stabilized polyethylene material. Other suitable assembly jacket materials include polyvinyl chloride (PVC), neoprene and polyurethane. The thickness of the cable assembly jacket material that surrounds each individual cable unit 110 can be from about 1 mm to about 3 mm. The thickness of the cable assembly jacket material at the indentation locations 122 can be from about 0.5 mm to about 1.5 mm. With this construction, the cable assembly, while having a generally planar profile, such as is shown in FIG. 1A, can have some flexibility. For example, the cable assembly 100 can be bent upwards or downwards at one or more indentation locations, thereby resulting in a curved shape in cross-section.

The individual cable units 110a-110f can each comprise a strengthened optical fiber cable. For example, FIG. 1B shows an exemplary individual cable unit 110a having two centrally located optical fibers 112a and 112b. The optical fibers can be conventional optical fibers having a conventional fiber diameter of 250 μm or 900 μm. In an alternative aspect, the cables can be implemented as hybrid cables, having both power lines and fiber communication lines.

Strength members 114a and 114b can also be included in cable unit 110a to provide axial strength along the length of the cable. Strength members 114a, 114b can be formed from conventional strength member materials such as fiber reinforced plastic, metal rods or wires, and/or aramid fibers.

In one aspect of the present invention, each individual cable unit 110 comprises a conventional dual fiber, FRP-type cable, such as those available from Aksh Technologies, Furakawa, and other commercial suppliers. In an alternative aspect, each individual cable unit can include a single fiber or multiple fibers, depending on the cell tower antenna configuration and signal provider requirements.

The cable assembly 100 can be formed by overjacketing extrusion, where an existing wire or cable is pulled through an extrusion die and a new jacket is extruded over it.

With this unitary construction, the entire cable assembly can be field terminated with a conventional optical fiber connector, as explained in more detail below.

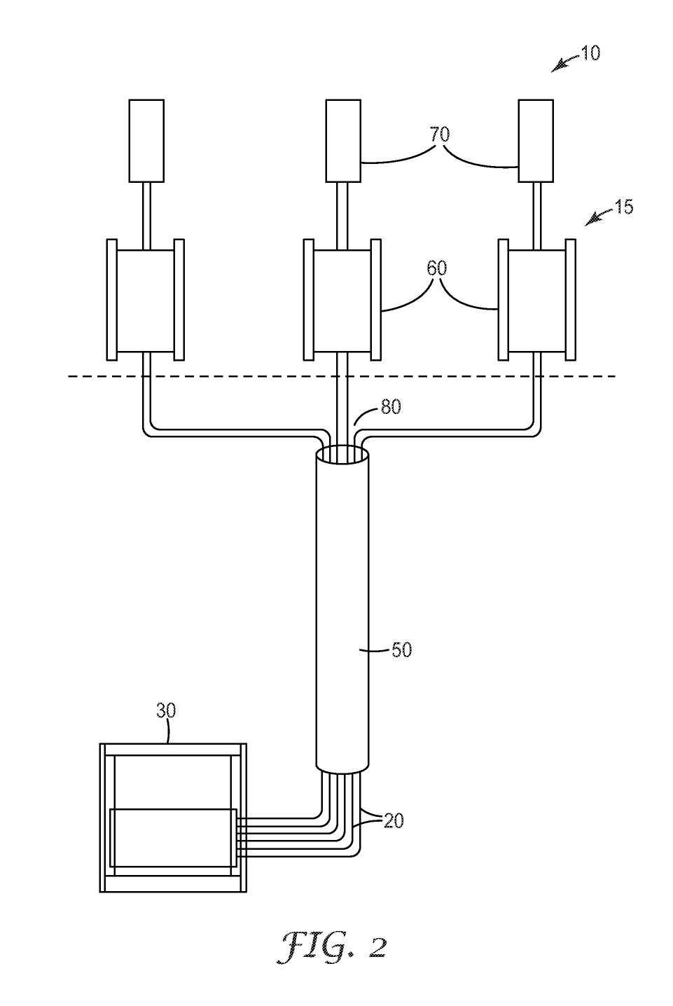

The cable assembly of the present invention can be effectively utilized in cell tower applications. By way of background, as shown in FIG. 2, generally in cell tower installations, individual optical fiber cables for carrying communication signals and power cables (labeled as cables 20 in FIG. 2) are routed up a cell tower 10 from a base station or site support cabinet 30 on the ground through a conduit 50 that runs up the side of the cell tower to a point near the remote radio units 60 and corresponding antennas 70 which can be located over a hundred feet in the air on the cell tower. The optical fibers and electrical lines can be provided to the top of the tower in media specific cables or can be provided in hybrid cables which contain both optical fibers and electrical power lines.

The conventional cell tower 10 shown in FIG. 2 includes one tier of three antennas 70. Cell towers can include additional antenna tiers and/or additional antennas per tier as required for a particular network configuration. The equipment and antennas on each tier may belong to a separate telecommunications carrier. Each the three antennas in a given tier provide cell signal reception for a 120° sector around the cell tower.

In many conventional tower installations the top of conduit 50 is open such that rain, snow, ice and debris can enter the conduit's open end. In cold climate, droplets of water on the interior walls of the conduit and on the cables within the conduit can freeze. These frozen droplets will attract additional moisture or water droplets which in turn will also freeze. Eventually, the entire internal space within the conduit can fill with ice. Because water expands as it freezes, the ice within the conduit can exert a compressive force on the cables within the conduit resulting in signal attenuation.

Additionally, the weight of the cables is typically supported at an anchor located just above the branch point, typically through the use of a Kellems wire grip available from Hubbell Incorporated (Shelton Conn.) attached to the cell tower 10. When ice forms in the conduit, the wire grips must also carry the weight of the ice that has formed on the cables in addition to the weight of the cable itself which can require a larger cable grip that would be needed to support the cable alone.

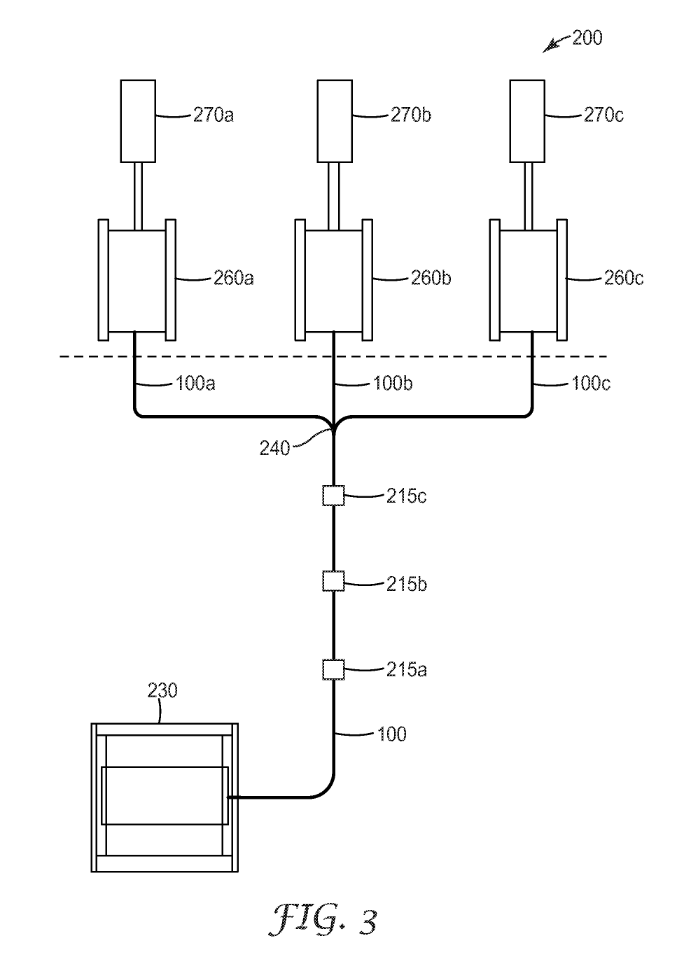

According to another aspect of the present invention, a tower cabling system, such as system 200 shown in FIG. 3, can utilize the tower cable assembly 100 described above to provide communication signals to cell tower antennas while avoiding the problems associated with current cell tower configurations, such as shown in FIG. 2. In the example of FIG. 3, a tower base station 230, located on the ground at or near the cell tower base, is coupled to cable assembly 100. In this example, cable assembly 100 is configured in the same manner as in FIG. 1A, where the cable assembly includes six individual cable units, each having two optical fibers. The cable assembly jacket 120 keeps the individual cable units together, thus removing the need to use a conduit to manage and route the optical fibers up the cell tower to the antenna locations. Instead, the cable assembly 100 can be routed as a unitary structure up the cell tower. At several locations up the cell tower frame, cable guides, such as cable guides 215a-215c can be used to ensure general cable positioning up the cell tower (e.g., to prevent wind or other forces from moving the cable assembly 100 from side-to-side).

Near the top of the cell tower, the cable assembly 100 can be furcated into a number of smaller groupings of fiber cables at a furcation location. The cable assembly can be supported at or near the furcation location by one or more Kellems wire grips or similar devices. For example, as shown in FIG. 3, cable assembly 100 is furcated into three groups at furcation location 240: cable subassembly 100a, cable subassembly 100b, and cable subassembly 100c, with each cable subassembly having two sets of duplex fibers. Furcation can be accomplished by applying a simple cutting tool or bladed tool at a cable assembly indentation location along the axial length of the cable assembly.

In this example, the cell tower tier is configured with three cell tower antennas. Each cable subassembly is then routed to a remote radio unit RRU location near an antenna (in this example, cable subassembly 100a is routed to RRU 260a, cable subassembly 100b is routed to RRU 260b, and cable subassembly 100c is routed to RRU 260c). In an exemplary aspect, the sets of duplex fibers can be implemented a number of different ways. In one implementation, the sets of duplex fibers can be implemented as a working set of duplex fibers and a spare set of duplex fibers. In another implementation, at each RRU, each pair of fibers can be further divided to send and receive units, each with an active and a spare fiber.

Each optical fiber can be field terminated with an optical fiber connector so that the optical fiber can be connected to a respective RRU. For example, a field installable LC-type or SC-type connector (e.g., the 8800 series LC and SC connectors, available from 3M Company), such as the LC-type NPC Connector, or the field mountable TLC Connector, also available from 3M Company, can be utilized. A grommet or molded rubber piece can be utilized to fit over the cable at the RRU maintenance window port. The field termination operation can be accomplished either at the base location or at the RRU location. As the individual cable units remain jacketed throughout the routing, a sealed terminal or closure is not required at a furcation (or other) location.

In an alternative aspect, the cell tower tier to be connected can have four antennas and associated RRUs. In this alternative example, the cable assembly can include eight individual optical fiber cable units.

Thus the cable assembly and system of the aspects of the invention provide a unitary construction that allows optical fiber cables to be entirely field prepared. The length of the furcated cable to the RRUs and the non-furcated cable assembly length can be determined in the field. No additional gels, shrink materials, or terminal boxes or closures are required at the furcation location.

Although specific embodiments have been illustrated and described herein, it will be appreciated by those of ordinary skill in the art that a variety of alternate and/or equivalent implementations may be substituted for the specific embodiments shown and described without departing from the scope of the present invention. This application is intended to cover any adaptations or variations of the specific embodiments discussed herein. Therefore, it is intended that this invention be limited only by the claims and the equivalents thereof.

1. A cable assembly for cell tower communications, comprising:
a plurality of optical fiber cable units disposed within a unitary cable assembly jacket that surrounds the optical fiber cable units, the cable assembly jacket having a plurality of indentations disposed between adjacent optical fiber cable units that allow an installer to furcate the cable assembly into smaller cable groupings at a convenient cell tower location.

2. The cable assembly of claim 1, wherein each optical fiber cable unit includes duplex fibers.

3. The cable assembly of claim 1, wherein each optical fiber cable unit includes strength members.

4. The cable assembly of claim 1, wherein each optical fiber cable unit is configured as an FRP cable.

5. The cable assembly of claim 1, wherein the cable assembly jacket is formed from a UV stabilized polyethylene material.

6. The cable assembly of claim 1 comprising at least six optical fiber cable units.

7. The cable assembly of claim 1 comprising at least eight optical fiber cable units.

8. A cell tower cabling system, comprising:
a cable assembly having a plurality of optical fiber cable units disposed within a unitary cable assembly jacket that surrounds the optical fiber cable units, the cable assembly jacket having a plurality of indentations disposed between adjacent optical fiber cable units, each optical fiber cable unit configured to carry a communications signal to or from a cell tower base station; and
a furcation location near the cell tower antennas, wherein the cable assembly is furcated into multiple subassemblies of cable units that are routed to remote radio units disposed near the antenna locations.

9. The cell tower cabling system of claim 8, further comprising:
a plurality of cell tower cable guides disposed on a cell tower frame to position the cable assembly as it routed up the cell tower.

10. The cell tower cabling system of claim 8, wherein each subassembly includes two sets of duplex fibers.

11. The cell tower cabling system of claim 10, wherein each subassembly can be further divided to send and receive units located at a respective remote radio unit, wherein each cable unit includes an active fiber and a spare fiber.

12. A cable assembly, comprising:
a plurality of optical fiber cable units disposed within a unitary cable assembly jacket that surrounds the optical fiber cable units, the cable assembly jacket having a plurality of indentations disposed between adjacent optical fiber cable units that allow an installer to furcate the cable assembly into smaller cable groupings at furcation locations, and route smaller cable groupings to different locations, wherein the optical fiber cable units remain jacketed throughout the routing.

13. The cable assembly of claim 12, wherein the cable unitary cable assembly jacket is extruded over the optical fiber cable units.

14. The cable assembly of claim 12, wherein the cable assembly is capable of being furcated by a simple cutting tool or bladed tool.

15. The cable assembly of claim 12, wherein each cable unit contains a single fiber.

16. The cable assembly of claim 12, wherein each cable unit contains multiple fibers.

17. The cable assembly of claim 12, wherein each cable unit comprises aramid fiber strength members.

18. The cable assembly of claim 12, wherein the cable units comprise hybrid cable units.

19. The cable assembly of claim 18, wherein the hybrid cable units comprise both power lines and fiber communication lines.
